(19) United States
(12) Patent Application Publication
(10) Pub. No.: US 2025/0198213 A1
(43) Pub. Date: Jun. 19, 2025

(54) FURNITURE DRIVE FOR DRIVING A MOVABLE PIECE OF FURNITURE

(71) Applicant: Julius Blum GmbH, Hoechst (AT)

(72) Inventors: Klaus MATTLE, Koblach (AT); Alexander Peterlunger, Lustenau (AT)

(21) Appl. No.: 19/069,772

(22) Filed: Mar. 4, 2025

Related U.S. Application Data
(63) Continuation of application No. PCT/AT2023/060300, filed on Aug. 30, 2023.

(30) Foreign Application Priority Data
Sep. 9, 2022 (AT) A 50686/2022

(51) Int. Cl. E05F 15/614; E05F 15/627

(52) U.S. Cl. CPC E05F 15/614; E05F 15/627; E05Y 2900/20

(57) ABSTRACT

A furniture drive for driving a movable furniture part, including an electric motor, an actuator, preferably movable back and forth between two end positions, for exerting force on the furniture part to be driven, and a transmission connected between the electric motor and the actuator. The electric motor has a maximum diameter of less than 18 mm, preferably less than 16 mm.

The present application is a continuation of International Application PCT/AT2023/060300 filed on Aug. 30, 2023. Thus, all of the subject matter of International Application PCT/AT2023/060300 is incorporated herein by reference.

### BACKGROUND OF THE INVENTION

The invention relates to a furniture drive for driving a movable furniture part comprising at least one electric motor, at least one actuator, preferably movable back and forth between two end positions, for exerting force on the furniture part to be driven, and a transmission connected between the electric motor and the actuator, as well as a furniture comprising at least one movable furniture part, preferably in the form of a flap that can be opened upwards, and at least one such furniture drive.

Such furniture drives with electric motors are already known from the prior art. For example, they enable the automatic opening of a furniture part. Servo motors are typically used hereby. These furniture drives have a relatively large design and, in the case of flap fittings, are attached to the flap fittings from the outside.

This creates a large space requirement on the one hand and a visually unappealing overall appearance on the other.

### SUMMARY OF THE INVENTION

The object of the invention is to provide a furniture drive that is improved compared to the prior art and a furniture with such an improved furniture drive.

According to the invention, it is therefore provided that the at least one electric motor has a maximum diameter of less than 18 mm, preferably less than 16 mm. This makes it possible to provide a furniture drive with a small space requirement. In particular, it is possible to arrange such a furniture drive hidden in a wall of furniture, which results in a visually appealing overall picture of the furniture.

In a furniture according to the invention, at least one such furniture drive is provided, wherein the furniture part is movably mounted on the furniture via the at least one furniture drive.

Preferably, the at least one electric motor is designed as an external rotor motor or as a disc rotor motor. By using these types of motors, the reduction of the size of an electric motor can be easily achieved.

In addition, a planetary gear can be interposed between the at least one electric motor and the transmission. This allows the speed of the electric motor to be adapted to the respective furniture drive. Preferably, the planetary gear essentially forms a structural unit with the at least one electric motor. Furthermore, the planetary gear can have a maximum diameter of less than 18 mm, preferably less than 16 mm. Finally, particularly preferably, a maximum diameter of the planetary gear substantially corresponds to the maximum diameter of the at least one electric motor. This ensures that the planetary gear does not increase the space required by the furniture drive and that the smallest possible size of the electric motor and planetary gear can be achieved.

In one embodiment, the furniture drive comprises at least one housing. The housing can be used on the one hand to protect the furniture drive and on the other hand to arrange components of the furniture drive. In addition, the housing can have at least one recess for receiving the at least one electric motor. This makes it easy to mount the electric motor.

Preferably, the housing can have a maximum width of less than 18 mm, preferably less than 16 mm. Particularly preferably, the maximum diameter of the electric motor substantially corresponds to the maximum width of the housing. This ensures that the electric motor does not take up more space than the housing. This means that the overall space requirement of the furniture drive can be kept to a minimum.

It has proven to be advantageous if the furniture drive has a bearing device, via which the at least one electric motor is mounted in and/or on the housing, and the bearing device comprises at least one damping element made of a sound-absorbing material. This avoids excessive noise during operation of the electric motor. In particular, a furniture wall or furniture cannot thus operate as a resonance body.

The transmission can have at least one crown gear transmission, bevel gear transmission, and/or worm gear transmission. Thus, a rotary movement of the electric motor can be converted accordingly.

In one exemplary embodiment, the transmission comprises between 3 and 9, preferably 6, transmission stages.

Preferably, at least one transmission device can be provided, with which the transmission is connected to the at least one actuator, preferably wherein the transmission device comprises at least one lever.

Further, the at least one electric motor and the transmission can be arranged in a first housing, with the actuator arranged in a second housing structurally separate from the first housing. Preferably, the two housings are arranged one above the other in a coupled state essentially in a common plane. This allows the furniture drive to be designed to save as much space as possible. In particular, the furniture drive can thus also be easily installed in a wall of a furniture.

It may also be advantageously conceivable that:
at least one lever arrangement is provided, via which the actuator is pivotally connected to the housing, and/or
at least one mechanical energy accumulator is provided, with which a force for compensating the weight of the furniture part to be driven can be exerted on the actuator, and/or
the actuator is arranged substantially completely in the housing in a first end position.

With regard to a furniture according to the invention, the furniture comprises at least one wall, and the housing of the at least one furniture drive is substantially completely inserted into a recess in the wall. This allows a furniture to be implemented in a space-saving and visually appealing way.

### BRIEF DESCRIPTION OF THE DRAWINGS

Further details and advantages of the invention are explained in more detail below with reference to the drawings, in which:

FIG. 1 is a schematic representation of a furniture,

FIG. 2 is a schematic representation of a furniture in a partially exploded view,

FIG. 3 is a schematic side view of a furniture drive,

FIG. 4a is a schematic representation of a part of a furniture drive,

FIG. 4b is an exploded view of FIG. 4a, and

FIG. 5 is a schematic representation of a part of a furniture drive.

### DETAILED DESCRIPTION OF THE INVENTION

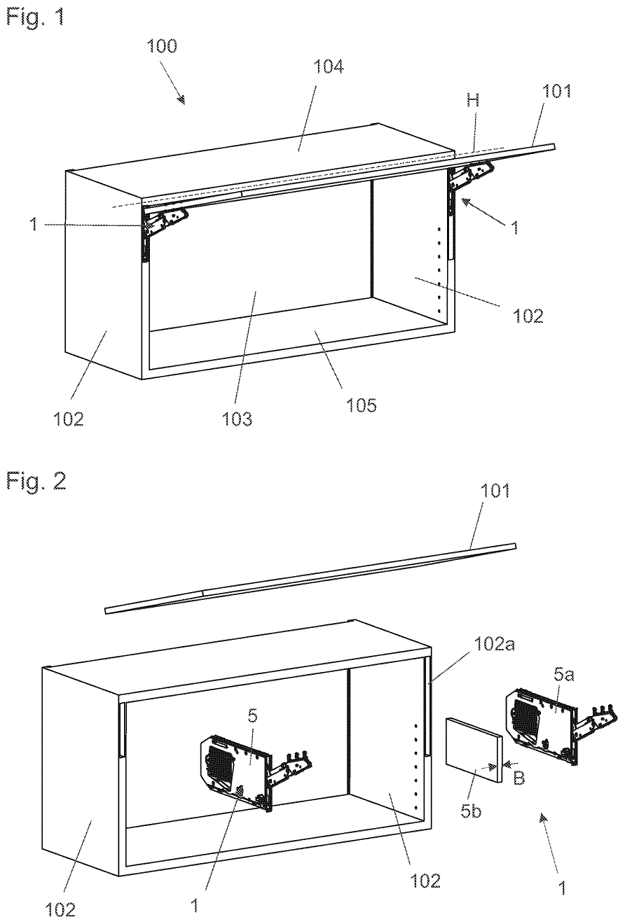

FIG. 1 shows a schematic representation of a furniture 100. The furniture comprises a body consisting of two furniture walls 102, a rear wall 103, a base 105 and a top 104. In addition, a movable furniture part 101 can be seen, which is connected to the furniture body via furniture drives 1, 1a so as to be pivotable about a horizontal axis H.

FIG. 2 shows the furniture from FIG. 1 in a partial exploded view.

A first housing 5a and a second housing 5b of a furniture drive 1 are visible, wherein the housings 5a, 5b preferably have a maximum width B of less than 18 mm, preferably less than 16 mm.

An electric motor 2 is arranged in the housing 5b, which is only shown schematically in FIG.

2. In particular, the actuator 3, which is connected or connectable to the furniture part 101, is pivotally arranged on the housing 5a.

Not all furniture drives 1 have to be provided with an electric motor drive unit. In the case shown, only one of the furniture drives 1 has an electric motor drive unit.

Alternative designs of a furniture are conceivable in which the furniture drives 1 according to the invention are used.

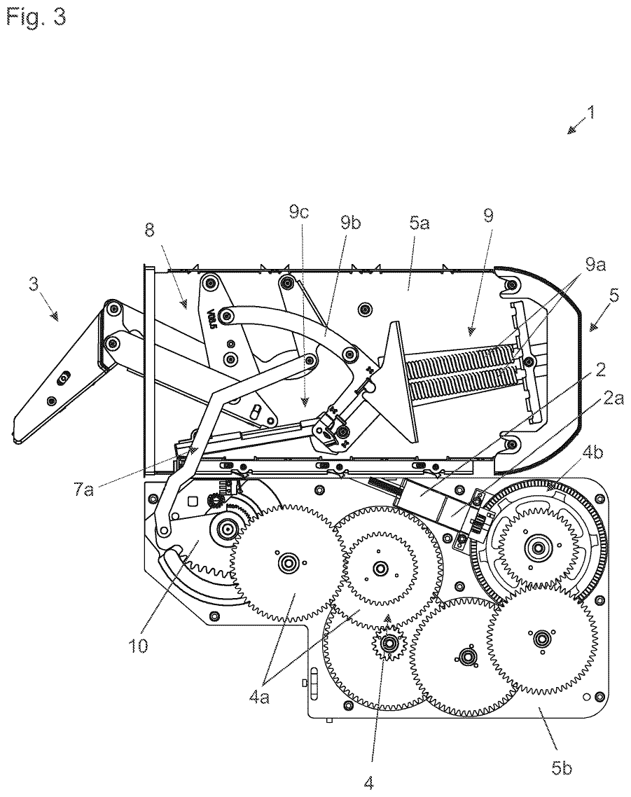

FIG. 3 shows a schematic side view of a furniture drive 1. The housing 5 is divided into a first housing 5a and a second housing 5b, wherein parts of the housings 5a, 5b are not shown in order to better illustrate the furniture drive 1.

The furniture drive 1 has at least one electric motor 2, at least one actuator 3, which can preferably be moved back and forth between two end positions, for exerting force on the furniture part 101 to be driven, and a transmission 4 connected between the electric motor 2 and the actuator 3.

A planetary gear 2a is also connected between the transmission 4 and the electric motor 2. It can be seen that the electric motor 2 and the planetary gear 2a essentially form a structural unit and have the same diameter.

The electric motor 2 and the transmission 4 can be arranged in a second housing 5b, as in the case shown, and the actuator 3 can be arranged on a first housing 5a, which is structurally separate from the second housing 5b, preferably wherein the two housings 5a, 5b are arranged one above the other in a coupled state essentially in a common plane.

At least one transmission device 7 is provided, with which the transmission 4 is connected to the actuator 3, wherein the transmission device 7 comprises at least one lever 7a.

Alternative embodiments of the transmission device 7 are also conceivable. In particular, the transmission device 7 is coupled to the transmission 4 via a non-circular gear 10.

At least one lever arrangement 8 is provided, via which the actuator 3 is pivotally connected to the housing 5a. In this specific case, the lever arrangement 8 forms a 7-joint arrangement.

At least one mechanical energy accumulator (9) is provided, with which a force for compensating the weight of the furniture part 101 to be driven can be exerted on the actuator 3. The mechanical energy accumulator 9 can have one or more compression springs 9a.

A force transmission lever 9b can be provided to transmit a force stored in the mechanical force accumulator 9 to the actuator 3.

Furthermore, a force adjustment device 9c can be provided, which can preferably be actuated from a front side of the first housing 5a and with which a spring preload of the springs 9c can be adjusted.

In a first end position, which corresponds to a closed position of the furniture part 101, the actuator 3 is arranged essentially completely in the first housing 5a.

The transmission 4 comprises several transmission stages, in which an overload and/or a freewheel clutch can also be integrated. The transmission stages can be formed by gears 4a of different sizes.

In this exemplary embodiment, the electric motor 2 is connected to the transmission via a crown gear 4b with the planetary gear 2a interposed. However, any other suitable connection is also conceivable, for example via a bevel gear or worm gear.

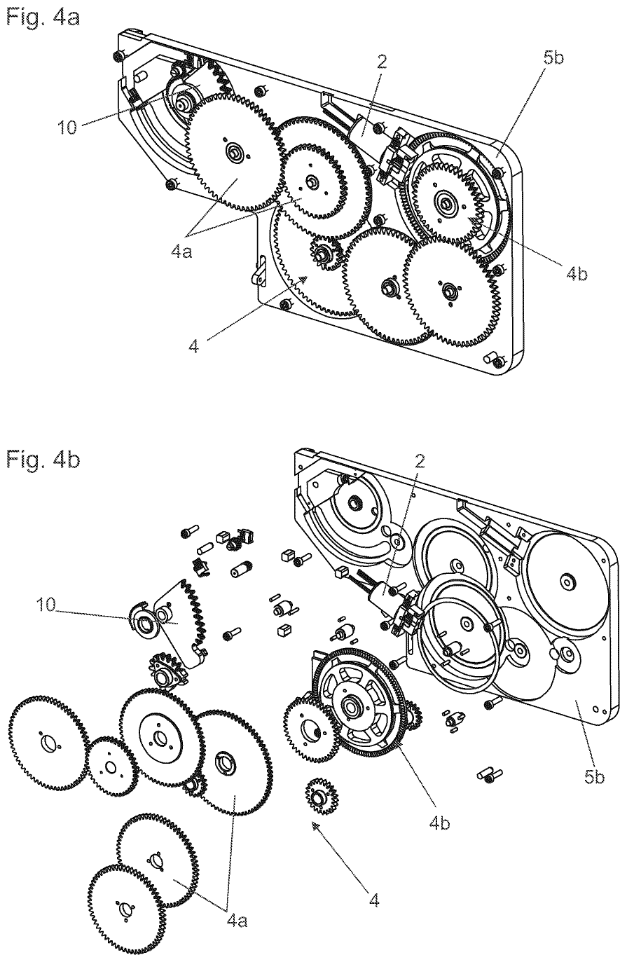

FIG. 4a shows a schematic representation of a part of a furniture drive 1, FIG. 4b shows an exploded view of FIG. 4a.

It can be seen that the transmission 4 is attached to the housing 5b. This makes it possible to achieve a design of the furniture drive 1 that is as space-saving as possible.

Furthermore, a recess 5c can be seen in the housing 5b, in which the electric motor 2 is mounted.

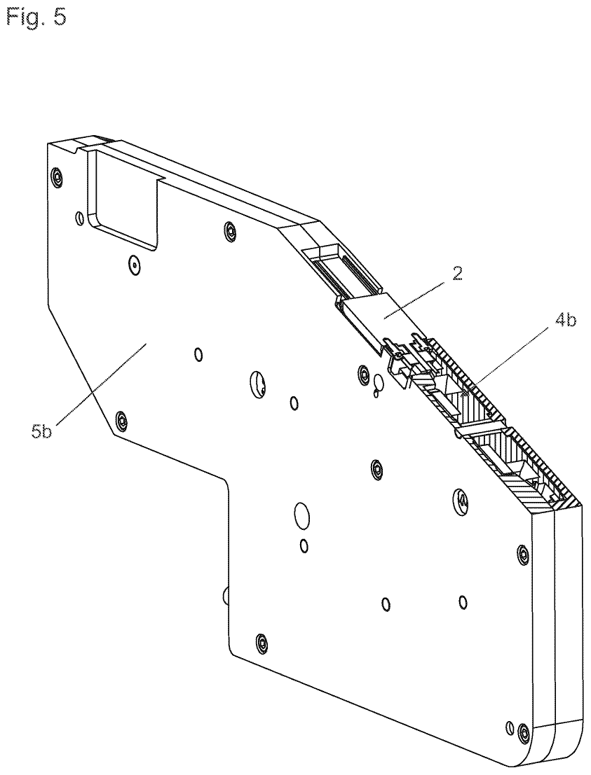

As the sectional view in FIG. 5 shows, this arrangement and the dimensions of the electric motor make it possible to realize a narrow furniture drive.

It can be seen in particular that the maximum diameter D of the electric motor 2 essentially corresponds to the maximum width B of the second housing 5b.

In the alternative exemplary embodiments according to FIGS. 4a to 5, no planetary gear 2a is interposed between the electric motor 2 and the transmission 4.

### LIST OF REFERENCE NUMERALS

1 furniture drive
2 electric motor
2a planetary gear
3 actuator
4 transmission
4a gears
4b crown gear
5 housing
5a first housing
5b second housing
6 bearing device
7 transmission device
7a lever
8 lever arrangement
9 energy storage
9a spring
9b force transmission lever
9c force adjustment device
10 non-circular gear
100 furniture
101 movable furniture part
102 furniture wall
102a recess
103 rear wall
104 top
105 base
B width
H horizontal axis

1. A furniture drive for driving a movable furniture part, comprising:
at least one electric motor,
at least one actuator, preferably movable back and forth between two end positions, for exerting force on the furniture part to be driven, and
a transmission connected between the electric motor and the actuator,
wherein the at least one electric motor has a maximum diameter of less than 18 mm, preferably less than 16 mm.

2. The furniture drive according to claim 1, wherein the at least one electric motor is an external rotor motor or as a disc rotor motor.

3. The furniture drive according to claim 1, wherein a planetary gear is interposed between the at least one electric motor and the transmission.

4. The furniture drive according to claim 3, wherein the planetary gear essentially forms a structural unit with the at least one electric motor.

5. The furniture drive according to claim 3, wherein the planetary gear has a maximum diameter of less than 18 mm, preferably less than 16 mm.

6. The furniture drive according to claim 3, wherein a maximum diameter of the planetary gear substantially corresponds to the maximum diameter of the at least one electric motor.

7. The furniture drive according to claim 1, wherein the furniture drive comprises at least one housing.

8. The furniture drive according to claim 7, wherein the housing has at least one recess for receiving the at least one electric motor.

9. The furniture drive according to claim 7, wherein the housing has a maximum width of less than 18 mm, preferably less than 16 mm.

10. The furniture drive according to claim 7, wherein the maximum diameter of the at least one electric motor substantially corresponds to the maximum width of the housing.

11. The furniture drive according to claim 7, wherein the furniture drive has at least one bearing device, via which the at least one electric moto is mounted in and/or on the housing, wherein the at least one bearing device comprises at least one damping element made of a sound-damping material.

12. The furniture drive according to claim 1, wherein the transmission has at least one crown gear, bevel gear and/or worm gear.

13. The furniture drive according to claim 1, wherein the transmission comprises between 3 and 9, preferably 6, gear stages.

14. The furniture drive according to claim 1, wherein at least one transmission device is provided, with which the transmission is connected to the at least one actuator, preferably wherein the transmission device comprises at least one lever, a toothing and an element interacting therewith and/or a belt.

15. The furniture drive according to claim 1, wherein the at least one electric motor and the transmission are arranged in a first housing and the actuator is arranged on a second housing which is structurally separate from the first housing, preferably wherein the two housings are arranged one above the other in a coupled state essentially in a common plane.

16. The furniture drive according to claim 1, wherein:
at least one lever arrangement is provided, via which the actuator is pivotally connected to the housing, and/or
at least one mechanical energy accumulator is provided, with which a force for compensating the weight of the furniture part to be driven can be exerted on the actuator, and/or
the actuator is arranged substantially completely in the housing in a first end position.

17. An item of furniture, preferably an upper cabinet, comprising:
at least one movable furniture part, preferably in the form of a flap that can be opened upwards, and
the furniture drive according to claim 1, wherein the furniture part is movably mounted on the furniture via the at least one furniture drive.

18. The item of furniture according to claim 17, wherein the furniture comprises at least one wall, wherein the housing of the at least one furniture drive is substantially completely inserted into a recess in the wall.
